(19) United States
(12) Patent Application Publication
(10) Pub. No.: US 2007/0008633 A1
(43) Pub. Date: Jan. 11, 2007

(54) Objective lens holder and pickup apparatus having same

(75) Inventor: Jing-Wei Su, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/483,217

(22) Filed: Jul. 7, 2006

(30) Foreign Application Priority Data
Jul. 9, 2005 (CN) 200520061394.8

(51) Int. Cl. G02B 7/02

(52) U.S. Cl. 359/824

(57) ABSTRACT

An objective lens holder includes a body, a plurality of sideboards, and a plurality of ribs. The body defines a through hole therein for receiving an objective lens. The sideboards extend downwardly from the body round the through hole to enclose an opening that communicates with the through hole for light passing therethrough. The ribs are connected between every two adjacent sideboards.

### BACKGROUND

1. Field of the Invention

The present invention relates to pickup apparatuses, and particularly to a pickup apparatus having an objective lens holder which does not generate a resonant vibration with an objective lens mounted therein.

2. General Background

Generally, a pickup apparatus defines a circular through-hole in an objective lens holder thereof for holding an objective lens therein. A loophole under the through-hole is defined in the objective lens holder for light passing therethrough to shine on the objective lens. The objective lens usually has a working frequency as well as the objective lens holder. The objective lens holder also has a natural vibration frequency. Ordinarily, the working frequency of the objective lens is low. In use, if the natural vibration frequency of the objective lens holder is also low, the objective lens holder may generate a resonant vibration with the objective lens. Thus, the objective lens holder may generate a big swing that would lead to abnormal functioning of the objective lens.

What is needed is to provide a pickup apparatus having an objective lens holder which doesn't generate a resonant vibration with an objective lens mounted therein.

### SUMMARY

An exemplary objective lens holder includes a body, a plurality of sideboards, and at least a rib. The body defines a through hole therein for receiving an objective lens. The sideboards extend down from the body to enclose an opening that communicates with the through hole for light passing therethrough. The rib is connected between two adjacent sideboards.

Other advantages and novel features of the invention will become more apparent from the following detailed description when taken in conjunction with the accompanying drawings, in which:

### BRIEF DESCRIPTION OF THE DRAWINGS

FIG. 1 is an exploded, isometric view of a pickup apparatus in accordance with a preferred embodiment of the present invention, the pickup apparatus includes an objective lens, and an objective lens holder;

FIG. 2 is an assembled view of the objective lens and the objective lens holder of FIG. 1;

FIG. 3 is similar to FIG. 2, but an inverted view; and

FIG. 4 is an isometric view of an objective lens holder in accordance with an alternative embodiment of the present invention.

### DETAILED DESCRIPTION OF THE EMBODIMENT

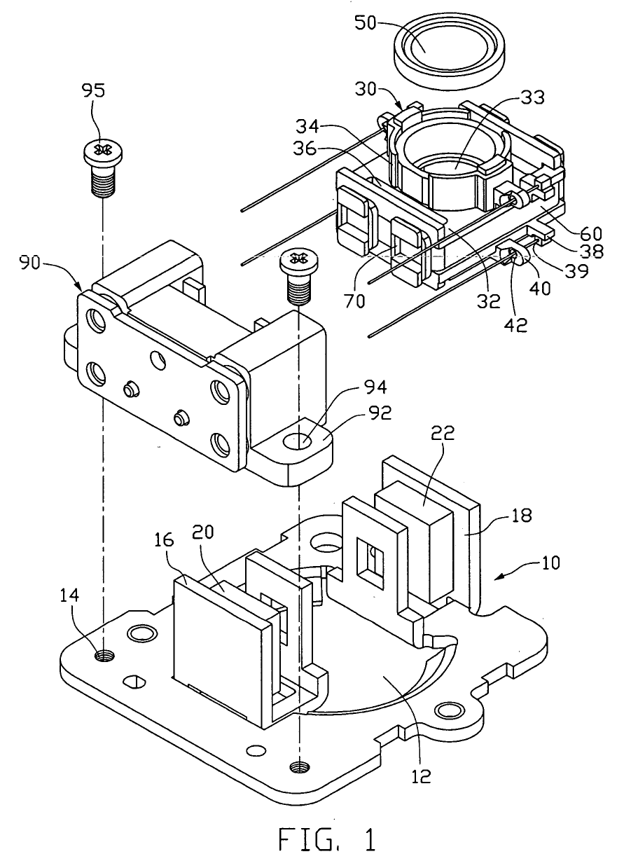

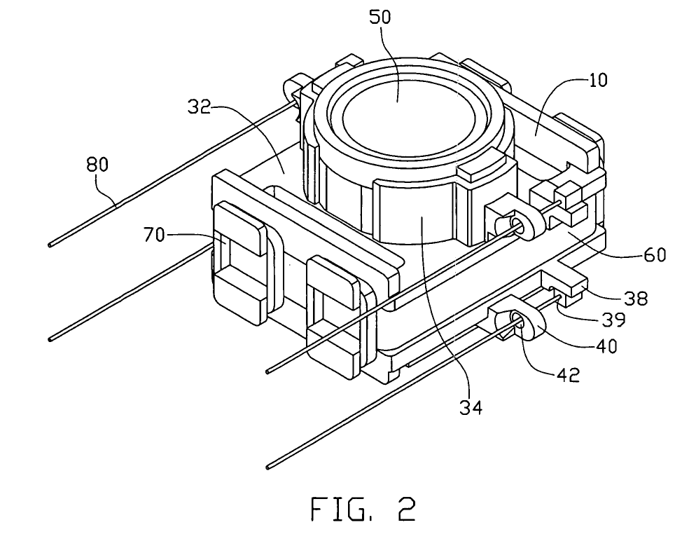

Referring to FIGS. 1 and 2, an optical pickup apparatus in accordance with a preferred embodiment of the present invention includes a base 10, an objective lens 50, an objective lens holder 30, a focus coil 60, four tracing coils 70, four linear elastic members 80, and a U-shaped mounting member 90.

The base 10 defines a loophole 12 in a center thereof for light passing therethrough. A pair of threaded holes 14 is defined in the base 10 and are generally positioned proximate the respective corners of a side. A pair of U-shaped yokes 16 and 18 opposite to each other protrudes up from sides of the loophole 12. The yoke 16 is located between the threaded holes 14. A magnet 20 is received in the yoke 16 and mounted to an inner sidewall of the yoke 16 away from the loophole 12. A magnet 22 is received in the yoke 18 and mounted to an inner sidewall of the yoke 18 away from the loophole. 12 North magnetic poles of the magnets 20 and 22 face a center of the loophole. 12

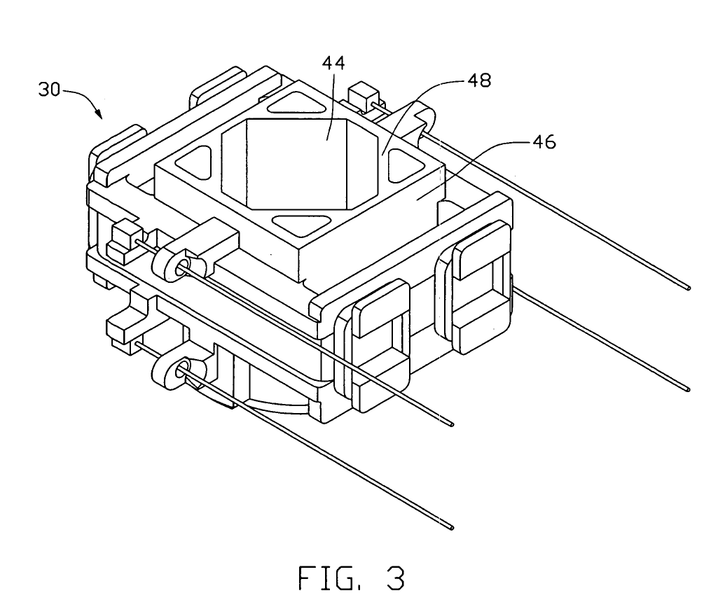

Referring also to FIG. 3, the objective lens holder 30 includes a rectangular body 32. A circular through hole 33 is defined in a center of the body 32. Aport defining a rectangular opening 44 therein extends down from the body 32. The opening 44 communicates with the through hole 33 for the light from, the loophole 12 passing therethrough. The port includes four sideboards 46 that enclose the opening 44 and further define inner sidewalls around the through sideboards 33. A lens barrel 34 extends from sides of the through hole 33 for holding the objective lens 50. A pair of slots 36 is defined in the body 32 for another of the sidewalls of the yoke 16 and 18 passing therethrough.

The focus coil 60 is mounted to the body 32 of the objective lens holder 30. A top surface of the focus coil 60 is perpendicular to an optical axis of the objective lens 50. The tracing coils 70 are mounted in pairs at two opposite sides of the body 32. The tracing coils 70 are mounted on a same plane parallel to the optical axis of the objective lens 50. Another two opposite sides of the body 32 each includes a pair of wrapping posts 38 extending therefrom. A first aperture 39 is defined in each wrapping post 38. The focus coil 60 is located between the wrapping posts 38. A mounting post 40 extends from the body 32 adjacent each wrapping post 38. A second aperture 42 aligning with a corresponding first aperture 39 is defined in each mounting post 40.

The mounting member 90 includes a pair of fixing portions 92 extending from opposite sides thereof. Each fixing portion 92 defines a locking hole 94 therein, corresponding to a corresponding threaded hole 14 of the base 10.

In assembly, one end of each linear elastic member 80 is received in a corresponding first aperture 39 and second aperture 42 of the body 32 to be mounted to the objective lens holder 30. The other end of each linear elastic member 80 is mounted to a circuit board (not shown) of the mounting member 90. The objective lens 50 is mounted to the lens barrel 34 of the objective lens holder 30. The combined assembly of the objective lens 50, the objective lens holder 30, the focus coil 60, the tracing coils 70, the linear elastic members 80, and the mounting member 90 is mounted to the base 10. The sidewalls of the yokes 16 and 18 adjacent the loophole 12 of the base are received into the corresponding slots 36 of the objective lens holder 30. The objective lens 50 is suspended above the loophole 12 of the base 10 via the linear elastic members 80. The locking holes 94 of the mounting member 90 align with the threaded holes 14 of the base 10. Screws 95 are inserted through the locking holes 94 to be engaged in the threaded holes 14. The yokes 16 and 18, magnets 20 and 22, focus coil 60, and tracing coils 70 form a voice coil motor. The linear elastic members 80 and the mounting member 90 form a suspension apparatus.

When an electric current flows past the focus coil 60, a Lorentz force acts on the focus coil 60 parallel to the optical axis of the objective lens 50. Thus, the focus coil 60 drives the objective lens holder 30 to move along the optical axis of the objective lens 50. When an electric current flows past the tracing coils 70, a Lorentz force acts on the tracing coils 70 perpendicular to the optical axis of the objective lens 50. Thus, the tracing coils 70 drive the objective lens holder 30 to move toward or away from the mounting member 90.

When the objective lens holder 30 moves, a working frequency is produced. The objective lens holder 30 also has a natural vibration frequency. To avoid a resonant vibration, the objective lens holder 30 needs a much higher natural vibration frequency than the working frequency. A natural vibration frequency of the objective lens holder 30 is determined by the following formula (1):

$${ω}_{0} = \sqrt{\frac{k}{m}} \qquad ( 1 )$$

ω₀ is the natural vibration frequency of the objective lens holder 30, k is a rigidity of the objective lends holder 30, and m is a mass of the objective lens holder 30. To increase the natural vibration frequency, the mass may be decreased or the rigidity may be increased. Less mass would be too difficult to achieve without sacrificing quality at the same time in this embodiment, a tabulate rib 48 or a rib portion is connected between every two adjacent sideboards 46 by extending between inner sidewalls of the through hole 33 to divide the opening 44 and its communicating through hole 33 into void parts, which comprise a central void part used as the main part of the opening 44 to transmit lights from the objective lens 50 and other void parts without transmitting the lights. The ribs 48 between the sideboards 46 increase both the rigidity and the mass of the objective lens holder 30. A new natural vibration frequency of the objective lens holder 30 is determined by the following formula (2):

$${ω}_{1} = \sqrt{\frac{k + Δ k}{m + Δ m}} \qquad ( 2 )$$

ω₁ is the new natural vibration frequency of the objective lens holder 30, Δk is a change in rigidity of the objective lends holder 30, and Δm is a change in mass of the objective lens holder 30. The effect of adding the ribs 48 causes a greater increase in the rigidity than in the mass of the objective lens holder 30, and so the following formula (3) is satisfied.

$$\frac{k + Δ k}{m + Δ m} > \frac{k}{m} \qquad ( 3 )$$

Thus, a higher natural vibration frequency of the objective lens holder 30 is produced.

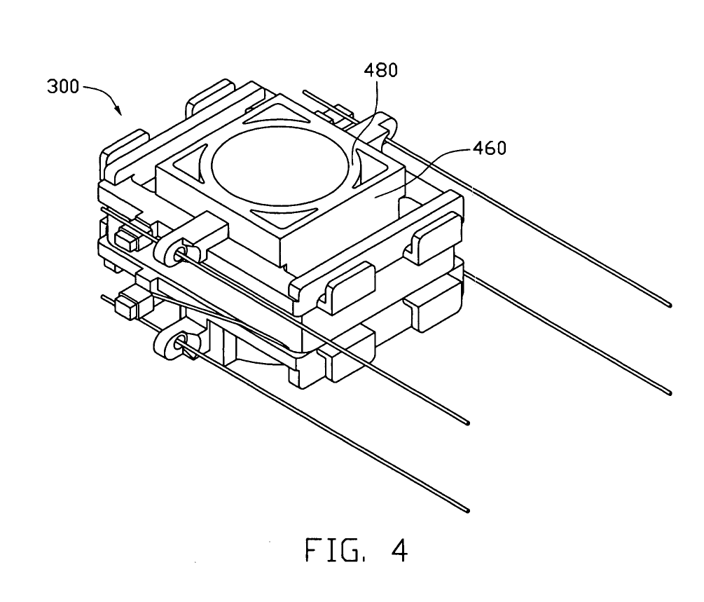

FIG. 4, shows an objective lens holder 300 in accordance with an alternative embodiment of the invention. The objective lens holder 300 is similar to the objective lens holder 30 of the above-mentioned embodiment. Ribs 480 between sideboards 460 of the objective lens holder 300 are cambered. The ribs 480 also make the objective lens holder 300 satisfy the above-mentioned formula (3).

It is believed that the present embodiments and its advantages will be understood from the foregoing description, and it will be apparent that various changes may be made thereto without departing from the spirit and scope of the invention or sacrificing all of their material advantages, the examples hereinbefore described merely being preferred or exemplary embodiments of the invention.

We claim:

1. An objective lens holder comprising:
a body defining a through hole therein for receiving an objective lens;
a plurality of sideboards extending down from the body defining an opening that communicates with the through hole for light passing therethrough; and
at least a rib connected between two adjacent sideboards.

2. The objective lens holder as claimed in claim 1, wherein said rib comprises a plurality of ribs connected between every two adjacent sideboards.

3. The objective lens holder as claimed in claim 2, wherein each of the ribs is tabulate.

4. The objective lens holder as claimed in claim 2, wherein each of the ribs is cambered.

5. A pickup apparatus comprising:
a base defining a loophole therein for light passing therethrough;
an objective lens;
an objective lens holder comprising a body defining a through hole therein for receiving the objective lens, a plurality of sideboards extending down from the body defining an opening that communicates with the through hole for the light from the loophole of the base passing therethrough, and at least a rib connected between adjacent two of the plurality of sideboards;
a suspension apparatus suspending the objective lens holder above the base; and
a voice coil motor driving the objective lens holder to move.

6. The pickup apparatus as claimed in claim 5, wherein said rib comprises a plurality of ribs consecutively connected between every two adjacent sideboards.

7. The pickup apparatus as claimed in claim 6, wherein each of the ribs is tabulate.

8. The pickup apparatus as claimed in claim 6, wherein each of the ribs is cambered.

9. An optical pickup apparatus comprising:
a first means of said optical pickup apparatus installed in said apparatus for performing optical pickup function for said apparatus;
an objective lens installable in said apparatus beside said first means to transmit light to/out of said first means;
an objective lens holder installable in said apparatus beside said first means, and defining a through hole to receive said objective lens therein in order for allowing light transmission of said objective lens via said through hole, at least one rib portion protrusively extending from a sidewall of said through hole to another sidewall of said through hole to divide at least one void part from said through hole while none of said light transmission of said objective lens happens via said at least one void part; and
a second means of said optical pickup apparatus installable in said apparatus beside said holder for moving said holder and said received objective lens in said holder.

10. The apparatus as claimed in claim 9, wherein an opening is defined at an end of said through hole, and said at least one rib portion comprises a plurality of rib portions respectively extending between every two adjacent sidewalls of said through hole at comers of said opening.
